(19) United States
(12) Patent Application Publication
(10) Pub. No.: US 2002/0161699 A1
(43) Pub. Date: Oct. 31, 2002

(54) Method of invitation to alteration of contract of cash loan for consumption

(75) Inventors: Yoshiya Okamoto, Kawasaki (JP); Makoto Sawada, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 09/942,642

(22) Filed: Aug. 31, 2001

(30) Foreign Application Priority Data
Apr. 27, 2001 (JP) 2001-130838

(51) Int. Cl. G06F 17/60

(52) U.S. Cl. 705/38

(57) ABSTRACT

A method of invitation to alteration of a contract of cash loan for consumption, which makes it possible to discover a potential customer with whom a new contract can be made and promote making of the new contract. When a creditor issues an itemized statement of use and a bill and/or executes a reminding process, invitation target customers each satisfying conditions for being a defaulting debtor or a candidate defaulting debtor are extracted from all debtors, and each of the extracted debtors is notified of an address of a Web site at which a service is provided for guiding customers to new contracts. At the Web site, a payment plan which is to be followed after alteration of present contract contents is simulated, and when the debtor can consent to a result of the simulation, a procedure for altering the present contract contents can be taken instantly. Since debtors eligible for new contracts are each extracted as invitation target customers, and a payment plan which is to be followed under a new contract can be checked instantly, it is possible to promote making of a contract with each extracted debtor.

### BACKGROUND OF THE INVENTION

1. Field of the Invention

This invention relates to a method of invitation to a contract of cash loan for consumption, and more particularly to a method of this kind for inviting a defaulting debtor or a highly potential defaulting debtor (customer) who made a contract of cash loan for consumption with a credit loan firm, a company performing credit business, a financial institution, such as a bank, a consumer loan firm, or the like, as a creditor, to alter the contract into a new one with relaxed terms of payment.

2. Description of the Related Art

Recently, in the financial industry, competition has been becoming increasingly fierce due to entry of many companies from various other industries. As a result, loan companies tend to eliminate membership fees conventionally imposed on credit card members and/or reduce service fees imposed on their own affiliated stores.

On the other hand, an increasing number of credit card users tend to prefer an installment payment or revolving payment plan which allows easy monthly payment to a lump-sum payment plan without interest cost.

Further, credit card users are increasing in number who desire a payment plan which is more flexible in dates and places of payment than the installment payment plan or the revolving payment plan, even if interest cost is higher. In such a payment plan, dates of payment are not fixed, differently from the installment payment plan or the revolving payment plan, but it is possible to pay the balance of a loan or a number of installments at one time, for instance, if a user can afford, but on the other hand defer part of payment until a bonus month or increase the number of installments if the user cannot afford to pay by predetermined installments. Further, as far as a place of payment is concerned, the user can use an ATM (automatic teller machine) of a bank or a post office for the payment and even pay at a convenience store.

In accordance with the above trends, financial firms desire to guide customers to long-term loans and high-interest financial products.

Conventionally, when a credit card company does not receive payment from a card user by a due date, the company reminds the card user that the payment is due. In such a case, if the card user does not have enough money for the payment, he may look for another loan company and borrow money from the firm for the payment to the card company. This process requires the user to follow a new procedure for borrowing, i.e. take various steps starting from application through inspection to granting of a loan, which is troublesome and time-consuming to the card user. In short, it costs the user time and labor to borrow money from another loan company to pay for the original installment.

The above process just seems to help the card company receive the payment according to a contract with the card user. Actually, however, the card company misses a chance to secure a new contract.

### SUMMARY OF THE INVENTION

It is an object of the invention to provide a method of invitation to alteration of a contract of cash loan for consumption, which makes it possible to discover a potential customer with whom a new contract can be made and promote making of the new contract with the potential customer.

To attain the above object, the present invention provides a method of invitation to alteration of a contract of cash loan for consumption for inviting a debtor to alteration of contract contents concerning payment terms. This method is characterized by comprising the steps of extracting invitation target customers each satisfying predetermined conditions from debtors, notifying each of the extracted debtors of an invitation to alteration of present contract contents to other contract contents which allow relaxation of payment terms, and information concerning reception of an application for the alteration of the present contract contents, simulating a payment plan which is to be followed after the alteration to the other contract contents, based on an access from the debtor, and taking a procedure for altering the present contract contents when the debtor consents to the alteration to the new contract contents based on a result of the simulation.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a flowchart showing a basic flow of a method of invitation to alteration of a contract of cash loan for consumption, according to an embodiment of the invention;

FIG. 2 is a view showing the construction of a system for putting the FIG. 1 invitation method into practice;

FIG. 3 shows overall processing for invitation to changeover to a new credit card;

FIG. 4 shows an example of a data structure of a contract master file;

FIG. 5 shows an example of a data structure of a customer master file;

FIG. 6 shows an example of a data structure of a commodity master file;

FIG. 7 shows an example of a data structure of billing data;

FIG. 8 shows an example of a data structure of an invitation target customer master file;

FIG. 9 shows an example of a data structure of history data;

FIG. 10 shows an example of a data structure of money reception data/reminder data file;

FIG. 11 shows an example of a data structure of an invitation target customer extract master file;

FIG. 12 is a flowchart showing an invitation target customer-extracting process which is executed during billing data generation; FIG. 13 is a flowchart showing an invitation target customer-extracting process which is executed during reminder data generation;

FIG. 14 shows an example of an E-mail notification containing information of refinance; FIG. 15 is a flowchart showing a flow of an online process;

FIG. 16 shows an upper half of an example of a Web screen provided for a customer utilizing an individual article installment plan;

FIG. 17 shows a lower half of the example of the Web screen provided for a customer utilizing the individual article installment plan;

FIG. 18 shows an upper half of an example of an Web screen provided for a customer utilizing a conventional credit card;

FIG. 19 shows the lower half of the example of the Web screen provided for a customer utilizing the conventional credit card; and

FIG. 20 is a diagram showing an example of hardware configuration of a server employed in the embodiment of the invention.

### DESCRIPTION OF THE PREFERRED EMBODIMENT

A preferred embodiment of the present invention will now be described below with reference to accompanying drawings.

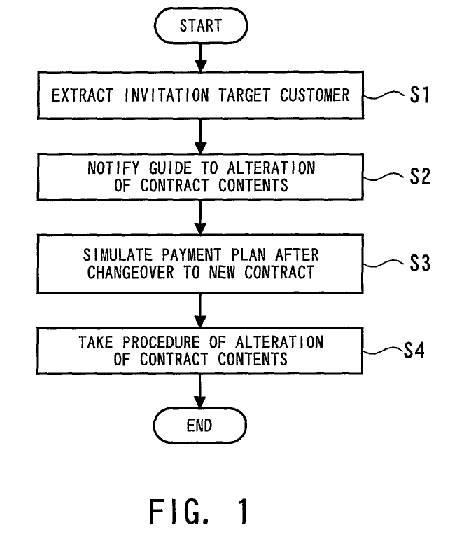

FIG. 1 is a flowchart showing a flow of basic processing carried out by a method of invitation to alteration of a contract of cash loan for consumption, according to the present invention.

The invitation to alteration of a contract of cash loan for consumption is started when an itemized statement of use and a bill are issued and/or when a reminder is issued to a debtor who did not pay at a due date. First, an invitation target customer who is a candidate defaulting debtor or satisfies conditions of a defaulting debtor is extracted from debtors (S1). Before this step, inspection has also been carried out to determine whether or not making of a contract with the debtor is possible if the debtor accepts the invitation.

Then, a notice inviting the debtor to the new contract with more relaxed payment terms than the present ones is sent to the extracted debtor by postal mail or Email (S2). At the same time, an Internet address (URL: uniform resource locator) of a Web site where a contract change can be applied for is added to the notice.

When reading the notice, the debtor accesses the Web site written therein to confirm the contents of the present contract displayed at the Web site and simulate a payment plan to be followed assuming that the present payment terms are changed to the introduced new ones (S3).

If the debtor can consent to alteration of the contents of the present contract to the new ones after viewing the simulation, he takes a procedure for alteration of the contents of the contract (S4).

This method makes it possible for a loan company to prevent a debtor as a customer of its own from moving to another loan company so as to avoid a temporary default. Further, since the inspection of invitation target customers is completed in advance, only debtors eligible for new contracts are extracted, and hence it is possible to promote making of the new contracts efficiently. The present method also makes it possible for a debtor not only to check a payment plan based on a new contract instantly on a Web site, but also to apply for the new contract on the Web site instantly on the spot without any need to undergo an inspection conventionally required for an application procedure of this kind. Thus, the method enables the debtor to go through the application procedure smoothly and readily in addition to eliminating the debtor's trouble of raising money newly for payment.

Next, a case of the embodiment of the present invention being applied to a transaction processing system in a credit company will be described in detail with reference to drawings.

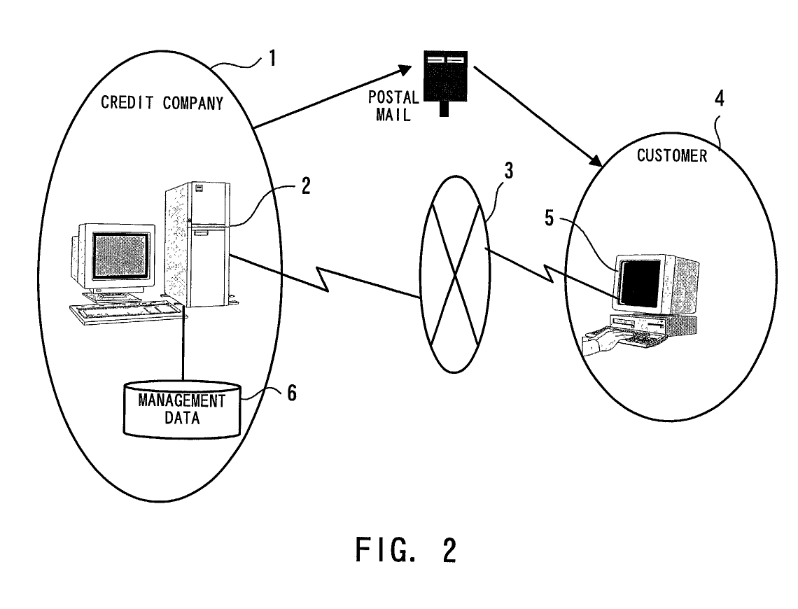

FIG. 2 shows the construction of a system for putting the invitation method of the invention into practice.

The credit company 1 has a server 2 installed therein which is implemented by a computer for performing transaction processing for customer management. The server 2 is connected to the Internet 3. A personal computer 5 operated by a customer 1 of the credit company 1 is also connected to the Internet 3.

The server 2 of the credit company 1 includes a disk 6 that stores management data needed for customer management and has an electronic mail-processing function of sending notices to customers by E-mail and a reception-at-Web-site function of receiving contract applications from customers at a Web site of the credit company 1.

On the other hand, the customer's personal computer 5 has an E-mail-receiving function of receiving notices E-mailed from the credit company 1 and a Web browsing function.

Now, let it be assumed that in the above construction of the system, a customer utilizing an individual article installment plan without using a credit card or one using a conventional credit card without a function of relaxing payment terms, such as a revolving payment function, is invited to changeover to a new credit card which allows payment terms to be relaxed. First, in a process of issuing an itemized statement of use and a bill, which is executed every month, or in a reminding process, the credit company 1 extracts a customer satisfying the conditions of the invitation target customer. Then, the credit company 1 invites the extracted customer by E-mail to change over to the new credit card and notifies him/her of the address of the Web site of the company 1 at the same time. If it is impossible to make contact with the customer by E-mail, the credit company 1 mails a letter informing him/her of the invitation to the use of the new card and the address (URL) of the Web site of the company 1.

After reading the invitation, the customer accesses the Web site written in the E-mail or mail notification, to confirm the contents of the present contract displayed on the Web site, and then simulates changes in his/her payment plan which will occur due to the use of the introduced new credit card, so as to recognize differences between the present payment plan and a new one using the new credit card. It is preferred that a remaining debt curve is displayed which is indicative of monthly changes in the remaining debt occurring when the payment is carried out every month.

If the customer agrees to the changeover to the new credit card after viewing the simulation, he can make an application for the changeover to the new card at the Web site.

Although in the above example, the customer 4 uses the personal computer 5 to receive the E-mail notification from the credit company 1 and make an application for the changeover to the new credit card in response to the invitation, it is possible to use a mobile terminal or a cellular phone, which has the same functions as the personal computer 5.

Next, description will be made of a flow of processing executed by the credit company 1.

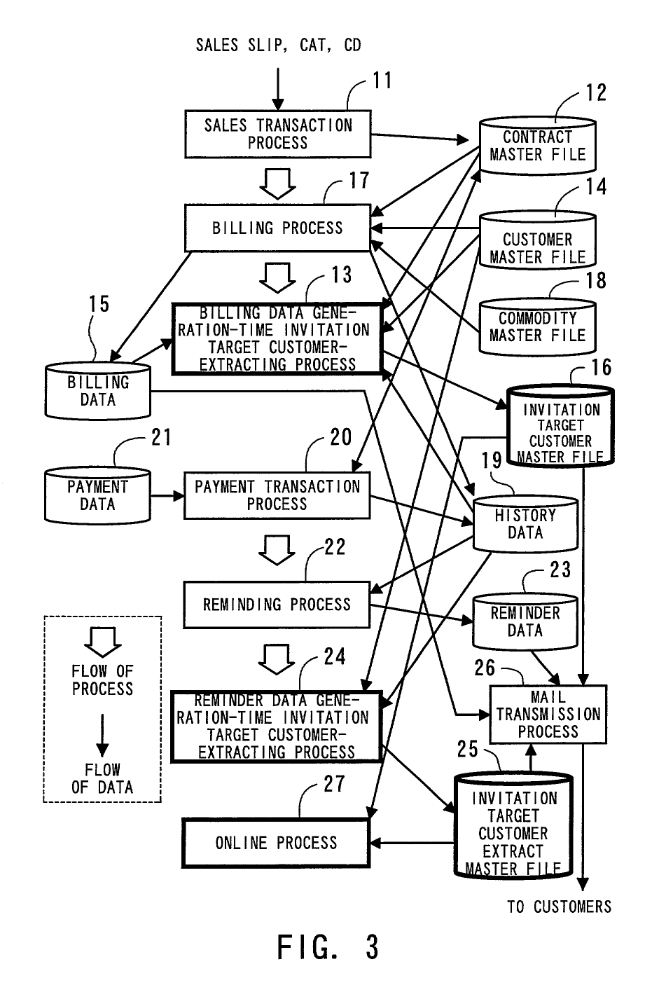

FIG. 3 shows overall processing for inviting a customer to a changeover to a new card.

The processing executed by the credit company 1 starts with a sales transaction process 11. The sales transaction process is performed on data of customers' purchases of articles, which are prepared based sales slips sent from affiliated stores, and received from credit authorization terminals (CAT) installed in the respective affiliated stores, cash dispensers (CD) for use in cashing, and so forth. The results of the sales transaction process are stored in a contract master file 12.

In a billing process 17, billing data 15 are generated based on data of the contract master file 12, a customer master file 14, and an commodity master file 18, and itemized statements of uses and bills are issued. At the same time, history data 19 is updated by adding new data items thereto.

In a billing data generation-time invitation target customer-extracting process 13, invitation target customers are extracted based on data stored in the contract master file 12, the customer master file 14, the billing data 15 and the history data 19, and data concerning the extracted customers are stored in an invitation target customer master file 16.

Then, in a payment transaction process 20, payment transaction is performed based on data stored in payment data 21 and the contract master file 12, and the contract master file 12 and the history data 19 are updated. In a reminding process 22, reminding is performed based on data stored in the history data 19, to generate reminder data, and the generated reminder data are stored in reminder data 23.

In a reminder data generation-time invitation target customer-extracting process 24, invitation target customers are extracted based on the customer master file 14 and the history data 19, and data of extracted customers are stored in an invitation target customer extract master file 25.

In a mail transmission process 26, bodies of invitation mails are generated based on the billing data 15, the reminder data 23, the data of extracted customers in the invitation target customer master file 16, and the data of extracted customers in the invitation target customer extract master file 25, and transmitted to invitation target customer's mail addresses.

Further, in an online process 27, in response to each request made by customers who accessed the Web site of the credit company 1, simulation of a payment plan to be followed after a changeover to the new credit card or reception of an application for the use of the new card is executed based on the customer data in the invitation target customer master file 16 or that in the invitation target customer extract master file 25.

The sales transaction process 11, billing process 17, payment transaction process 20, reminding process 22 and mail transmission process 26 of all the processes described above are also executed in a conventional transaction system.

Next, description will be given of examples of the data required for the transaction processing executed by the credit company.

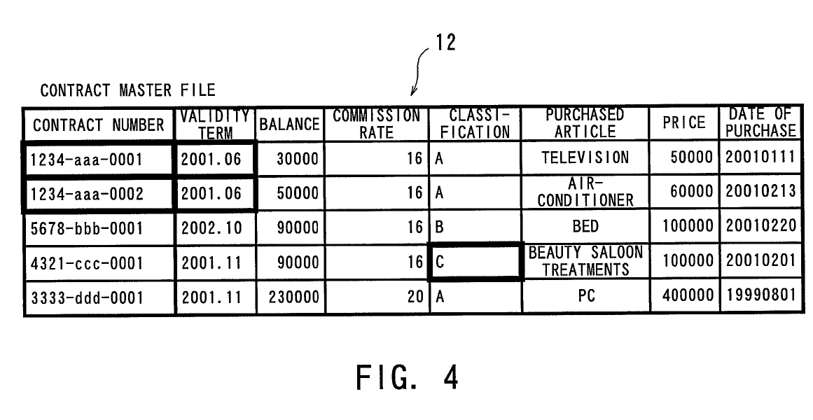

FIG. 4 shows an example of the data structure of the contract master file.

The contract master file 12 includes at least respective fields for a contract number, a validity term, a balance, a commission rate, a classification, a purchased article, a price, and a date of the purchase. The contract master file 12 stores data for respective contracts, i.e. data associated with respective article purchases each performed by a customer by using a credit card or utilizing an individual article installment plan. The classification in the contract master file 12 is data for identification of the kind of each credit card or each individual article installment plan, i.e. data concerning kinds of commodities defined in the commodity master file 18 described in detail hereinbelow. The contract master file 12 has data thereof updated whenever new data is received in the sales transaction process 11 through new entry of the data, and further has data of the balance thereof updated by the payment transaction process 20. Although in the present embodiment, a contract number is formed by adding a branching number to a customer number such that the customer number can be identified from the contract number, data of customer numbers may be separately stored in the contract master file 12.

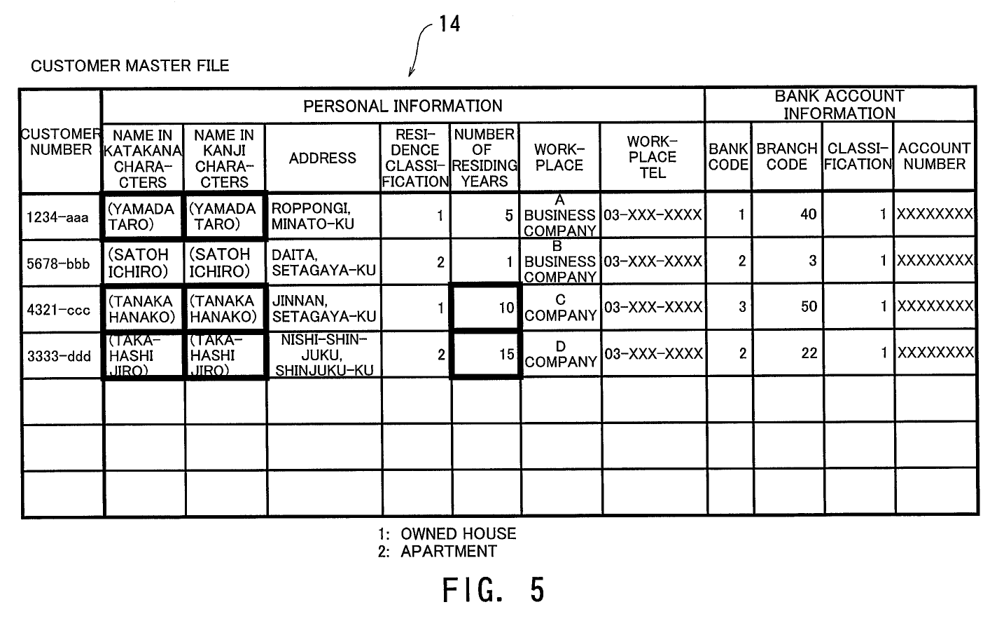

FIG. 5 shows an example of the data structure of the customer master file.

The customer master file 14 includes respective fields for a customer number, personal information, and bank account information. The field of the personal information is divided into respective fields for a personal name in katakana characters and the same in kanji characters, an address, a residence classification, the number of residing years, a workplace, and a workplace telephone number. The field of the account information is divided into respective fields for a bank code, a branch code, an account classification, an account number, a birth date, not shown, and so forth. In the illustrated example, “1” in the residence classification field represents an owned house, while “2” represents a rented house.

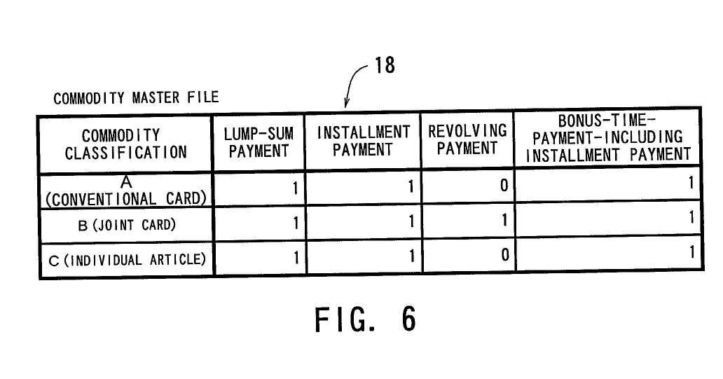

FIG. 6 shows an example of the data structure of the commodity master file.

The commodity master file 18 stores data defining payment methods available depending on the kind of a credit card. The commodity master file 18 includes respective fields for a commodity classification, a lump-sum payment method, an installment payment method, a revolving payment method, and a bonus-time-payment—including installment payment method. The illustrated example shows payment methods which can be employed with two kinds of credit cards and the individual article installment plan.

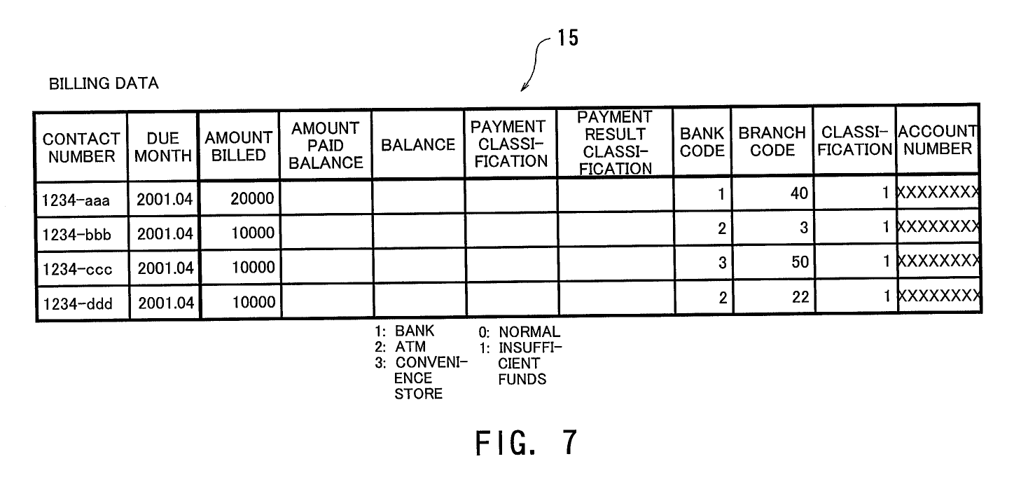

FIG. 7 shows an example of the data structure of the billing data.

The billing data 15 includes respective fields for a contract number, a due month, an amount billed, an amount paid, a balance, a payment classification, a payment result classification, a bank code, a branch code, an account classification and an account number. In this example, in the field of the payment classification, there is entered data indicative of which of a bank, an automatic teller machine (ATM) and a convenience store is used for payment. In the field of the payment result classification, there is entered data indicative of whether the payment transaction was normally performed or could not be performed due to insufficient funds.

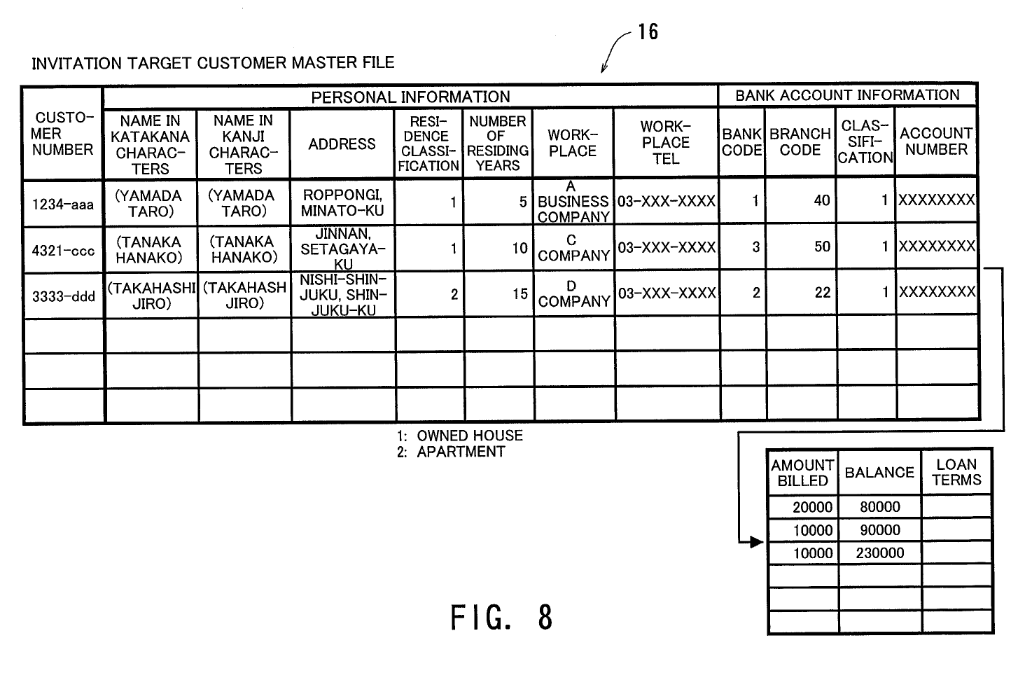

FIG. 8 shows an example of the data structure of the invitation target customer master file.

The invitation target customer master file 16 includes respective fields for a customer number, personal information, account information, an amount billed, a balance, and loan terms. The field of the personal information is divided into respective fields of a personal name in katakana characters, the same in kanji characters, an address, a residence classification, the number of residing years, a workplace, and a workplace telephone number, while the field of the account information is divided into respective fields of a bank code, a branch code, an account classification, and an account number.

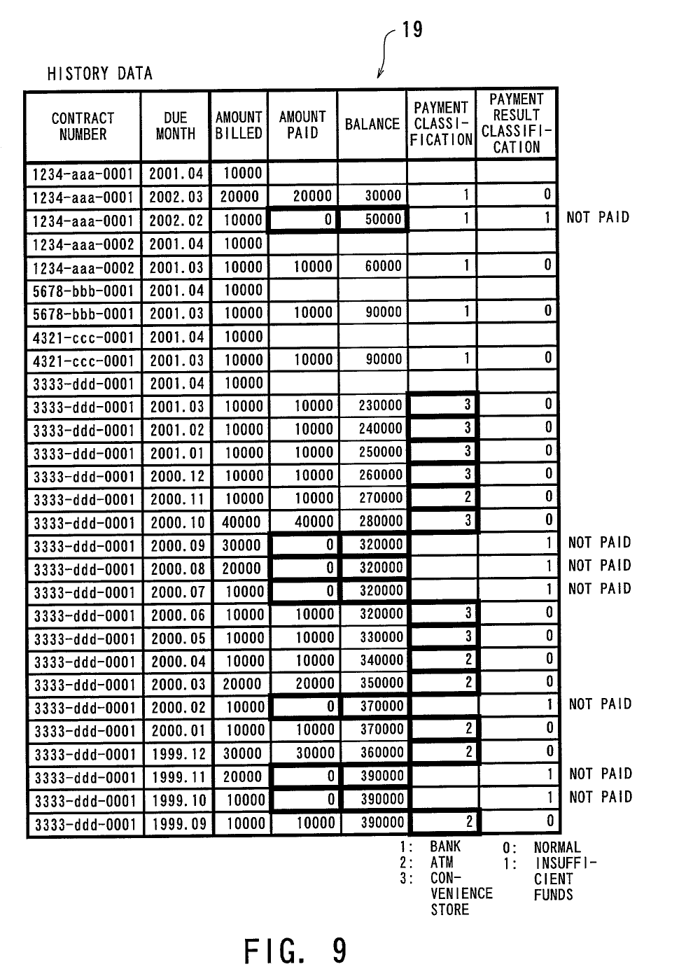

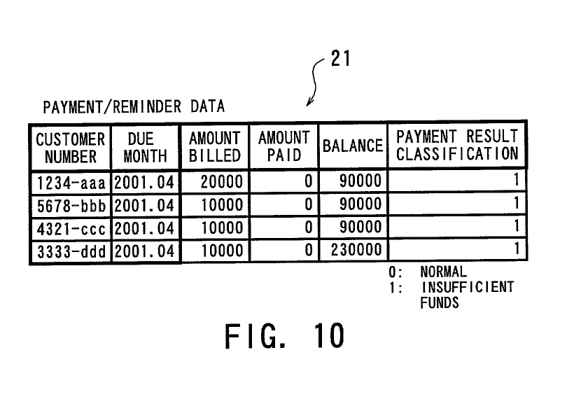

FIG. 9 shows an example of the data structure of the history data.

The history data 19 includes respective fields for a contract number, a due month, an amount billed, an amount paid, a balance, a payment classification, a payment result classification, and a payment date, not shown. In this example, in the field of the payment classification, there is entered data indicative of which of a bank, an automatic teller machine (ATM) and a convenience store is used for payment, while in the field of the payment result classification, there is entered data indicative of whether payment was normally performed or could not be performed due to insufficient funds.

The history data 19 is updated whenever new billing data is generated by the billing process 17 and added to the history data 19, and in the payment transaction process 20, the fields of the payment, balance, payment classification, payment result classification, etc. are updated. When a customer performs payment, the oldest one of data items concerning the customer's balance.

FIG. 10 shows an example of the data structure of the payment/reminder data.

The payment data 21 and the reminder data 23 each include respective fields for a contract number, a due month, an amount billed, an amount paid, a balance, and a payment result classification. The payment data 21 and the reminder data 23 have the identical data structures, as described above, since the payment data 21 is generated through the payment transaction process, and the reminder data 23 is formed by extracting only information of events of default from the payment data 21.

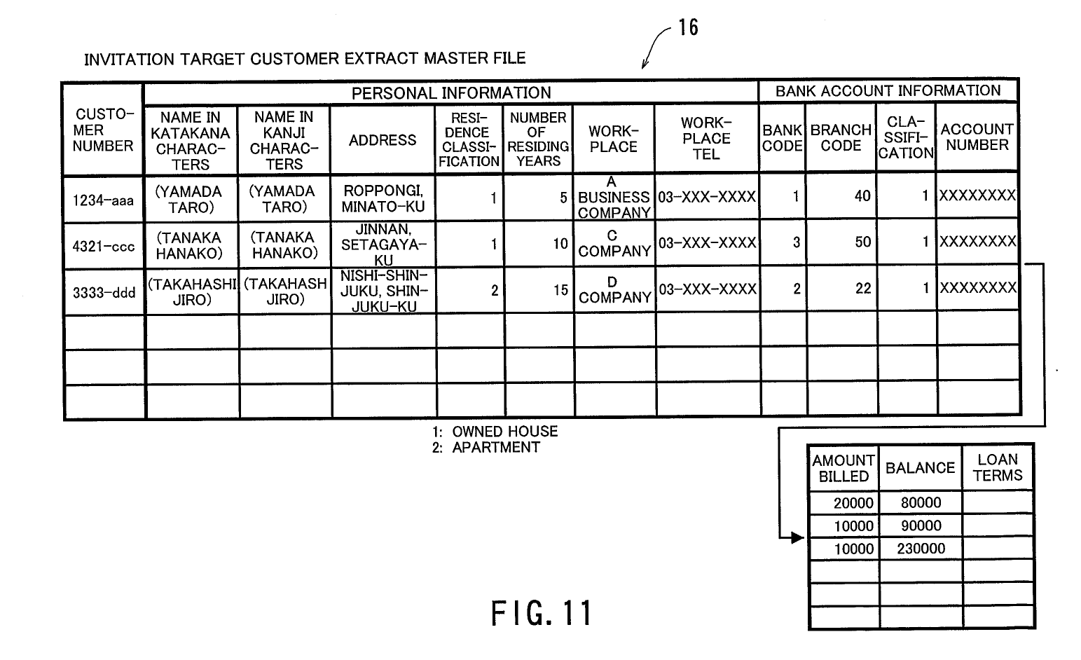

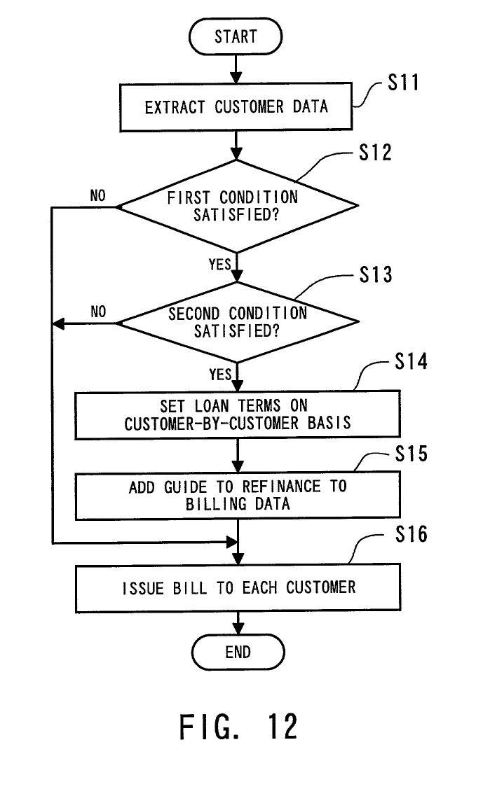

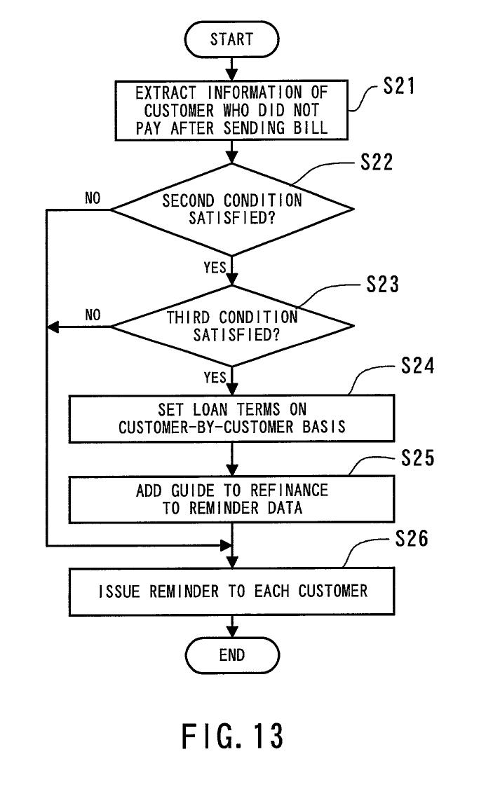

FIG. 11 shows an example of the data structure of the invitation target customer extract master file.

The invitation target customer extract master file 25 includes respective fields for a customer number, personal information, a bank account information, an amount billed, a balance, and loan terms. The field of the personal information is divided into a personal name in katakana characters, the same in kanji characters, an address, a residence classification, the number of residing years, a workplace, and a workplace telephone number, while the filed of the account information is divided into a bank code, a branch code, an account classification, and an account number.

Now, description will be given of processing for inviting a customer to a changeover to a new credit card which is executed during generation of the billing data.

FIG. 12 is a flowchart showing the invitation target customer-extracting process executed during generation of the billing data.

This process is carried out during processing for normal monthly issue of itemized statements of uses and bills so as to extract customers satisfying the conditions of the invitation target customer for the new card. The invitation target customer-extracting process is executed in the billing process 17 and the following billing data generation-time invitation target customer-extracting process 13.

First, at a step S11, from the contract master file 12, there are extracted data concerning customers who used their own cards in the present month, i.e. whose purchase date is in the present month, customers who are each paying for a plurality of articles bought on an installment plan by using an identical credit card, customers utilizing the individual article installment plan as indicated in the classification of the file, and customers using a credit card whose validity term will expire soon (e.g. within three months). Then, it is determined whether or not each of the extracted customers satisfies a first extracting condition, with reference to his/her history data 19 and the like corresponding to the extracted data (S12). In the present embodiment, it is assumed that the first extracting condition is satisfied when an amount billed for the present month is equal to or larger than a predetermined amount. If the first extracting condition is satisfied, it is determined whether or not a second extracting condition is satisfied, with reference to the extracted customer's data within the customer master file 14 (S14). The second extracting condition is satisfied when a customer has lived at an identical address for a predetermined number of years (e.g. three years) or longer, the customer has a job, and the customer is of a predetermined age (e.g. twenty) or older.

If the second extracting condition is satisfied, loan terms are set for each of the customers satisfying the conditions on a customer-by-customer basis (S14). The loan terms set a credit limit equivalent to a normal credit limit. For example, the credit limit is set based on a use of the credit system and a credit status of each customer. First, with reference to the field of classification in the contract master file 12, if the use of the credit system is clear such as an article purchase, the credit limit is set to a larger value, whereas when the use is unclear such as cashing, the same is set to a smaller value. Further, the credit status is determined with reference to the history data 19, and if payment has never been delayed in the past, the credit limit is increased, whereas if payment has been delayed in the past, the credit limit is not increased. Data which have been extracted before the step S14 and for which the credit limit is set at the step S14 are stored in the invitation target customer master file 16.

Then, data of a refinance guide or an invitation to a changeover to a new card is added to billing data of each customer who satisfied the first and second extracting conditions at the respective steps S12, S13 (S15). Then, with reference to the invitation target customer master file 16, a bill having the data of the refinance guide added thereto is issued to each of the customers satisfying the first and second extracting conditions, and a bill alone is issued to each customer who did not satisfy both of the extracting conditions (S16).

Next, description will be given of processing for invitation to a changeover to a new card which is executed during generation of reminder data.

FIG. 13 is a flowchart showing the invitation target customer-extracting process executed during the generation of reminder data.

This process is carried out during the payment transaction process 20 before transmission of a reminder to a customer who has not paid even after a due date, so as to extract customers satisfying the conditions of the invitation target customer for the new card. The invitation target customer-extracting process is executed in the reminding process 22 and the reminder data generation-time invitation target customer-extracting process 24.

First, information of each customer who has not paid even after a payment date (first extracting condition) is extracted with reference to the history data 19 updated with payment data 21 obtained in the payment transaction process 20 (S21). Then, with reference to data of each of the extracted customers within the customer master file 14, it is determined whether or not a second extracting condition is satisfied (S22). In this case, the second extracting condition is satisfied when a customer has lived at an identical address for a predetermined number of years (e.g. three years) or longer, the customer has a job, and the customer is of a predetermined age (e.g. twenty) or older. If the second extracting condition is satisfied, it is determined with reference to data in the history data 19 related to the extracted customer whether or not a third extracting condition is satisfied (S23). The third extracting condition is satisfied e.g. when default events occurred three or less consecutive times.

If the third extracting condition is satisfied at the step S23, loan terms are set for each of the extracted customers on a customer-by-customer basis (S24). The loan terms set a credit limit equivalent to a normal credit limit. For example, the credit limit is set based on a use of the credit system and a credit status of each customer. First, with reference to the field of the classification in the contract master file 12, if the use of the credit system is clear such as an article purchase, the credit limit is set to a larger value, whereas if the use is unclear such as cashing, the credit limit is set to a smaller value. Further, the credit status is determined with reference to the history data 19, and if payment has never been delayed in the past, the credit limit is increased, whereas when payment has been delayed in the past, the credit limit is not increased. Data which are extracted before the step S24 and for which the credit limit is set at the step S24 are stored in the invitation target customer extract master file 25.

Then, data of a refinance guide or an invitation to a changeover to the use of the new card is added to reminder data (S25). Then, a reminder having the data of the refinance guide added thereto is issued to each of the customers who satisfied the second and third extracting conditions at the respective steps S22, S23, and a reminder alone is issued to each customer who did not satisfy both of the extracting conditions (S26).

Further, in tandem with the issue of the itemized statements of uses and bills, a notification containing the refinance guide for inviting the use to a changeover to a new credit card may be sent by E-mail to all the members through the mail transmission process 26.

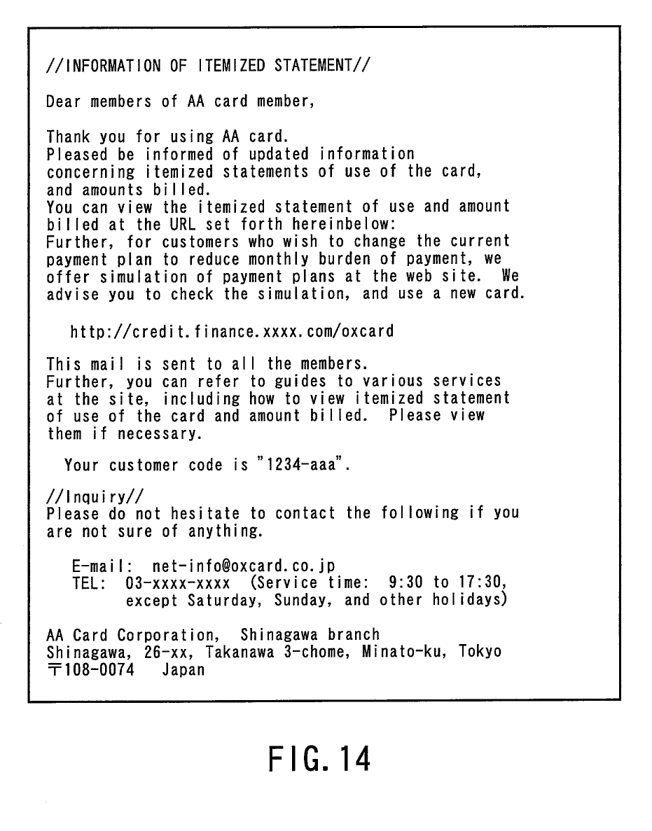

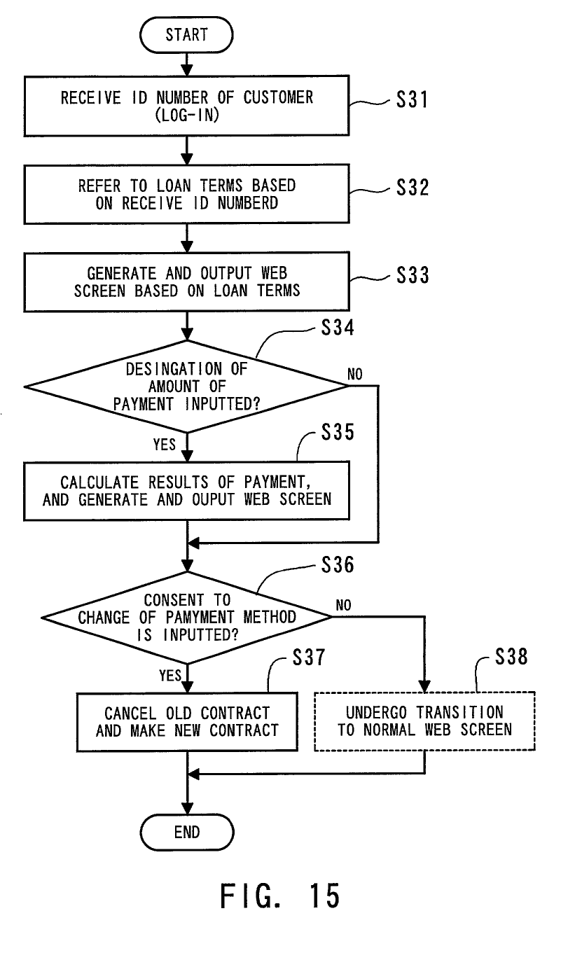

FIG. 14 shows an example of an E-mail containing a refinance guide.

The illustrated example of the E-mail contains information notifying a customer that there is a new credit card which allows present payment terms to be relaxed and that the customer can simulate a payment plan to be followed when the new card is used, as well as an Internet address (URL: Uniform Resource Locator) of the Web site providing the above service and a customer code required for the customer to log into the Web site. Thus, the customers of the credit company can access the URL shown in the E-mail so as to utilize necessary services.

Further, in tandem with the issue of the itemized statements of uses and bills and reminders, E-mails containing a refinance guide for invitation to a changeover to a new credit card may be sent individually to each of the customers extracted in the invitation target customer-extracting process, on a customer-by-customer basis.

Next, description will be given of the online process 27 which is executed when a customer accesses the URL given by postal mail or E-mail.

FIG. 15 shows the flow of the online process.

First, log-in processing is executed by receiving an identification number from the customer (S31). The identification number is a customer code notified to the user in advance. Entry of the customer code as the identification number received, and loan terms of the customer are looked up from the invitation target customer master file 16 or the invitation target customer extract master file 25 (S32). Then, a Web screen is generated based on information obtained from the billing data 15, the customer master file 14, etc. concerning the customer, and the above loan terms, and then outputted (S33).

Then, it is determined whether or not designation of an amount payable was inputted (S34). If the designation of an amount payable was inputted, the result of the payment is calculated, and then a Web screen is generated and outputted (S35). If designation of an amount payable was not inputted, the step S35 is skipped.

Next, it is determined whether or not consent to alteration of a payment method was entered (S36). If the customer's consent was received, an old contract is canceled and a new one is concluded (S37). If the customer's consent was not received, the process performs transition to an ordinary Web screen in response to an action instructed by the customer (S38).

Although in the above example, simulation of a payment plan is performed based on the designation of an amount payable, this is not limitative, but the simulation may be performed based on the number of installments specified and inputted by the customer.

Next, an example of the screen generated at the step S33 is illustrated.

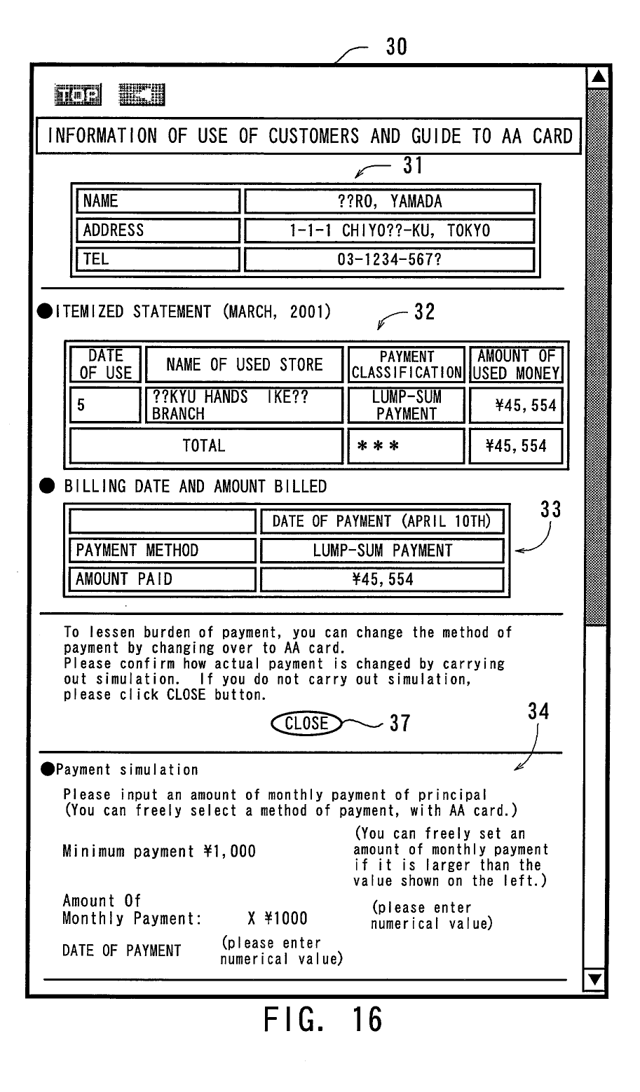

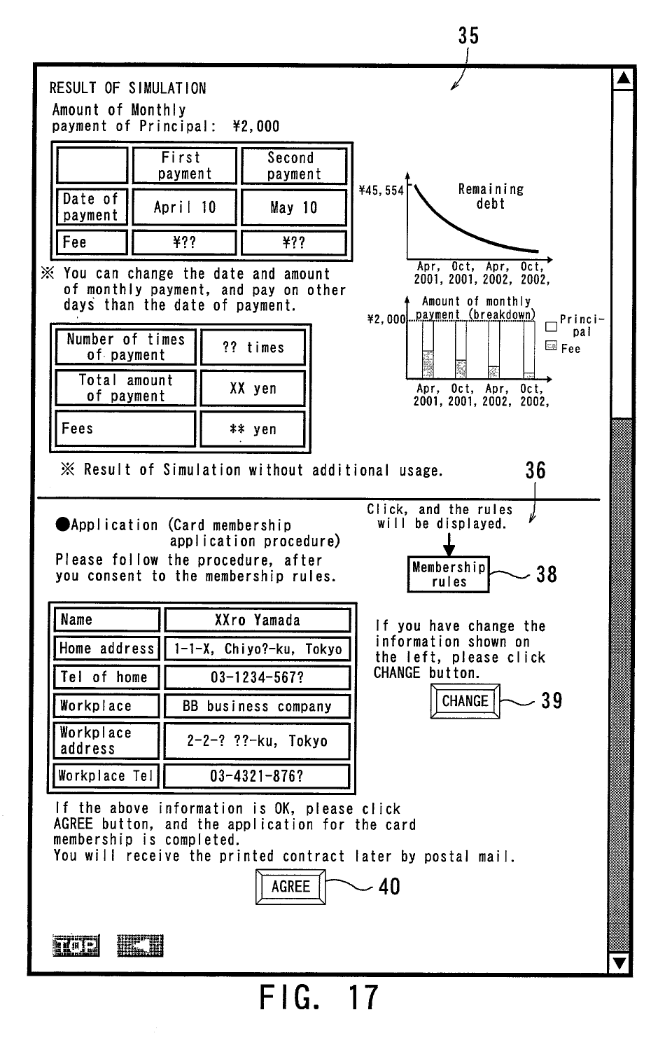

FIG. 16 shows the upper half of the example of the Web screen provided for a customer utilizing the individual article installment plan, while FIG. 17 shows the lower half of the same.

The Web screen 30 provided for a customer utilizing the individual article installment plan is displayed upon log-in of the customer from the top page of the Web site of the credit company. The Web screen 30 can be roughly divided into a display part 31 for displaying customer information, a display part 32 for displaying information concerning use details, a display part 33 for displaying information concerning a payment date and an amount billed, a condition entry part 34 for entering conditions for a payment simulation, a display part 35 for displaying a payment simulation result, and a display part 36 for displaying a procedure of application for a new credit card. The parts form one screen. Hidden part of the Web screen 30 can be viewed by scroll thereof.

The Web screen 30 has the display parts 31, 32, 33 arranged in the upper portion thereof, for allowing the customer to confirm the customer information and card use status of his/her own. If the customer does not want to alter a present payment method, he/she can close the Web screen 30 by depressing a CLOSE button 37.

In the condition entry part 34 for entering conditions for a payment simulation, a customer who wishes to view how the payment plan will change if he/she becomes a card member enters an amount payable and a payment date. In a payment box, a minimum payment is displayed as a lower limit for payment, and hence the customer enters an amount larger than the minimum payment. Then, the display part 35 for displaying a payment simulation result dynamically changes to display the result of the simulation. As the simulation result, payment dates, fees, the number of installments, and so forth are displayed with numerical values, and at the same time, a remaining debt curve chart indicative of changes in an outstanding balance and a breakdown of payment are also displayed.

Arranged in the display part 36 for displaying an application procedure are a button 38 for displaying membership rules for a new member, a CHANGE button 39 for use in altering the customer information displayed for confirmation, and a CONSENT button 40 which is depressed for application for card membership.

As described above, when a customer wants to take a procedure for becoming a card member, essential entry items requisite for an application are displayed based on the customer information the credit company has already acquired, so that the customer can change only items desired to be changed, and hence it is possible to considerably reduce time and labor conventionally required for the application procedure. Further, since the inspection required for determination as to whether a customer should be admitted as a card member is performed before a guide inviting the customer to the card membership is issued, it is possible to shorten a time period required to go through a contract procedure.

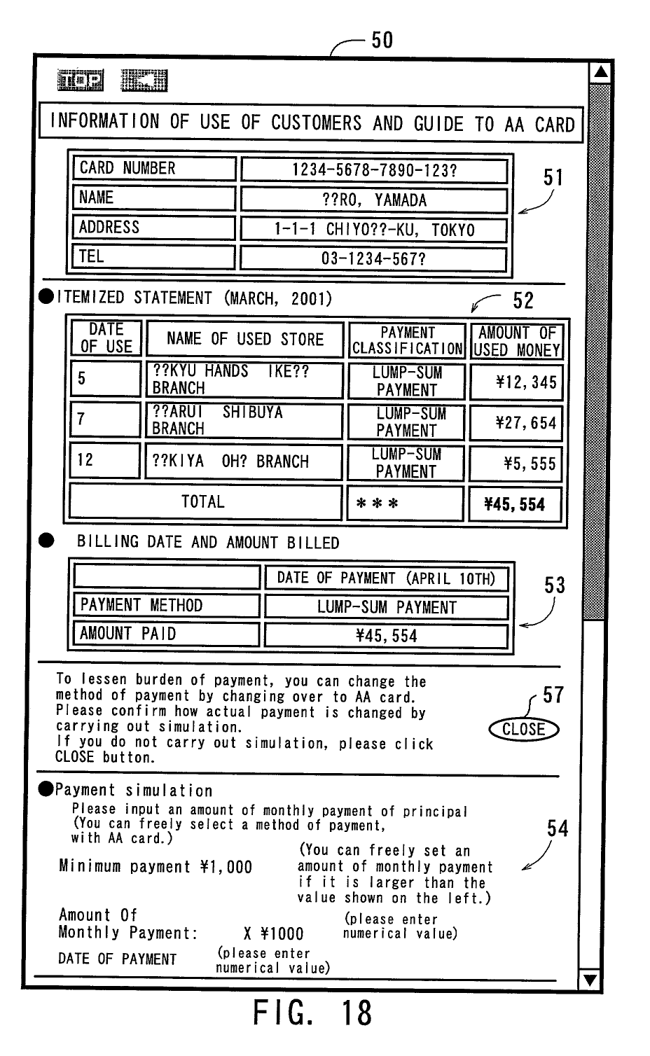

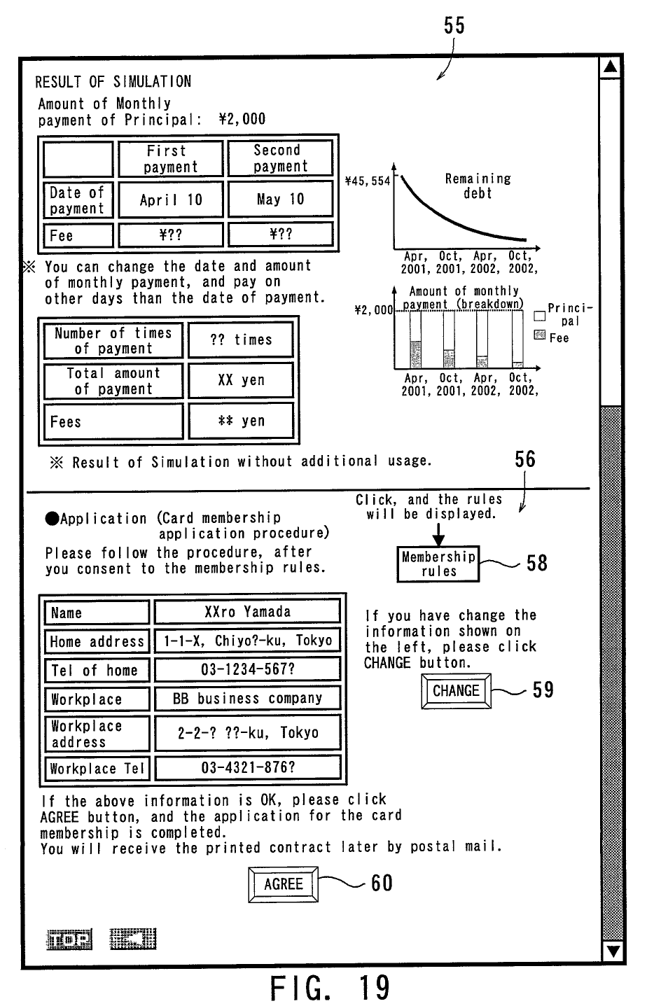

FIG. 18 shows the upper half of an example of an Web screen provided for a customer utilizing the conventional credit card, while FIG. 19 shows the lower half of the same.

The Web screen 50 provided for a customer utilizing the conventional card is displayed upon log-in of the customer from the top page of the Web site of the credit company. The Web screen 50 also includes a display part 51 for displaying customer information, a display part 52 for displaying information concerning use details, a display part 53 for displaying information concerning a payment date and an amount billed, a condition entry part 54 for entering conditions for a payment simulation, a display part 55 for displaying a payment simulation result, and a card change procedure display part 56. These parts form one screen. Hidden part of the Web screen 50 can be viewed by scroll thereof.

The Web screen 50 has the display parts 51, 52, 53 arranged in the upper portion thereof, for allowing the customer to confirm the customer card number, customer information and a status of card use of his/her own. If the customer does not wish to alter a present payment method, he/she can close the Web screen 50 by depressing a CLOSE button 57.

In the condition entry part 54 for entering conditions for a payment simulation, a customer who wishes to view how the payment plan will change if he/she changes over the conventional card to the new one, he/she enters an amount payable and a payment date. Then, the display part 55 for displaying a payment simulation result dynamically changes to display the result of the simulation.

Arranged in the card change procedure display part 56 are a button 58 for displaying membership rules applied to a changeover to a new card, a button 59 for use in altering the customer information displayed for confirmation, and a CONSENT button 60 which is depressed for application for the changeover.

As described above, when a customer wishes to take a procedure for a changeover to a new card, he/she does not need to input information of himself/herself, and hence it is possible to considerably reduce time and labor conventionally required for the application procedure. Further, since the inspection required for determination as to whether a customer should be admitted as a card member is performed before a guide inviting the customer to a changeover to a new card is issued, it is possible to shorten a time period required to go through the contract procedure.

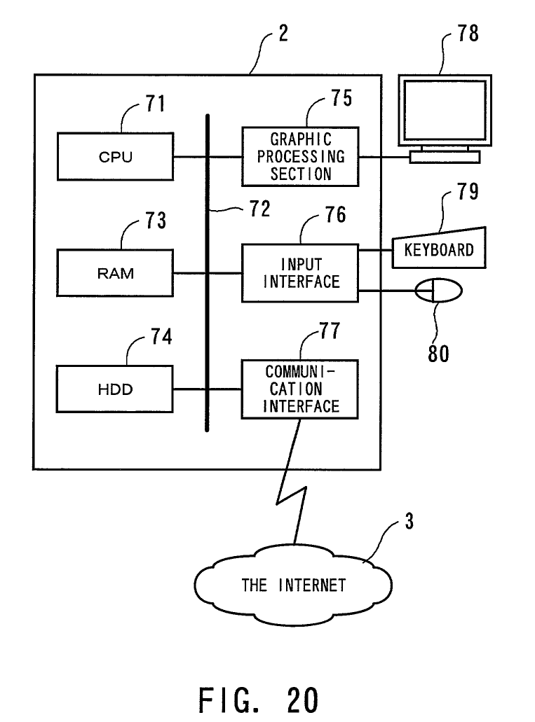

FIG. 20 shows an example of hardware configuration of a server for use in the embodiment of the present invention.

The overall operation of the server 2 is controlled by a CPU (Central Processing Unit) 71. The CPU 71 has a RAM (Random Access Memory) 73, a hard disk drive (HDD) 74, a graphic processing section 75, an input interface 76, and a communication interface 77, connected thereto via a bus 72.

The RAM 73 temporarily stores at least part of an OS (Operating System) program and business application programs, which are executed by the CPU 71. Further, the RAM 73 stores various kinds of data required for processing by the CPU 71. The HDD 74 stores the OS program and the business application programs of the credit company.

A monitor device 78 is connected to the graphic processing section 75. The graphic processing section 75 is responsive to a command from the CPU 71, for causing the monitor device 78 to display screens including an entry screen for management of the customer data. A keyboard 79 and a mouse 80 are connected to the input interface 76, which transmits signals from the keyboard 79 and the mouse 80 to the CPU 71 via the bus 72.

The communication interface 77 is connected to the Internet 3. The communication interface 77 pass E-mails and data of Web screens to be transmitted and received between customers' personal computers 5 via the Internet 3.

It should be noted that although in FIG. 20, the hardware configuration of the server 2 was described, each customer's personal computer 5 as a terminal device or a mobile terminal, such as a cellular phone, has a similar hardware configuration.

By causing the program for invitation to alteration of a contract of cash loan for consumption, according to the embodiment of the present invention to be executed by the FIG. 20 computer, it is possible to cause the computer to function as an apparatus for invitation to alteration of a contract of cash loan for consumption.

Further, details of processing to be executed by functions of each of the above computers can be written in a program stored in a computer-readable storage medium. By causing the program to be executed by the computer, it is possible to realize the above processing. The computer-readable recording media include a magnetic recording medium, and a semiconductor memory. To make this program available on the market, it can be stored in a portable recording medium, such as a CD-ROM (Compact Disk Read Only Memory) or a flexible disk. Further, the program can be stored in a storage device of a computer connected to a network, and transferred to other computers via the network. When the program is executed on a computer, the program stored in a hard disk drive or the like within the computer is loaded into a main memory for execution.

As described above, according to the present invention, when the billing process or the reminding process is carried out, invitation target customers satisfying predetermined conditions are extracted from all the debtors, and the extracted debtors are notified of an invitation to a new contract which allows relaxing of payment terms, together with information concerning application for contract alteration. Then, based on an access from a debtor notified of the above information, a payment plan to be followed after the contract alteration is simulated. As a result of the simulation, if the debtor finds that he can consent to the alteration to a new contract, he/she can instantly take a procedure for the contract alteration.

Thus, the creditor can prevent the debtor as its own customer from moving to another loan company for a fund required for a temporary repayment. Further, since inspections required for new contracts are completed during extraction of the invitation target customers, and only debtors eligible for new contracts are extracted, it is possible to efficiently promote making of new contracts. Moreover, since each debtor can check a payment plan based on a new contract instantly through a simulation and then apply for the new contract, it is possible to eliminate the customer's time and labor for raising a fund for repayment.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be resorted to, falling within the scope of the invention in the appended claims and their equivalents.

What is claimed is:

1. A method of invitation to alteration of a contract of cash loan for consumption for inviting a debtor to alteration of contract contents concerning payment terms,
the method comprising the steps of:
extracting invitation target customers each satisfying predetermined conditions from debtors;
notifying each of the extracted debtors of an invitation to alteration of present contract contents to other contract contents which allow relaxation of payment terms, and information concerning reception of an application for the alteration of the present contract contents;
simulating a payment plan which is to be followed after the alteration to the other contract contents, based on an access from the debtor; and
taking a procedure for altering the present contract contents when the debtor consents to the alteration to the new contract contents based on a result of the simulation.

2. A method of invitation to alteration of a contract of cash loan for consumption for inviting a debtor to alteration of contract contents concerning payment terms,
the method comprising the steps of:
extracting invitation target customers each satisfying conditions for being a defaulting debtor or a candidate defaulting debtor from all debtors;
notifying each of the extracted debtors, by postal mail or E-mail, of an invitation to alteration of present contract contents to other contract contents which allow relaxation of payment terms, and an address of a Web site at which an application for the alteration of the present contract contents is received;
simulating a payment plan which is to be followed after the alteration to the other contract contents, based on an access from the debtor; and
taking a procedure for altering the present contract contents when the debtor consents to the alteration to the new contract contents based on a result of the simulation.

3. A method of invitation to alteration of a contract of cash loan for consumption, according to claim 2, wherein the step of extracting the invitation target customers includes inspection for determining whether or not it is possible to make a contract with each of the debtors under the relaxed payment terms.

4. A method of invitation to alteration of a contract of cash loan for consumption, according to claim 2, wherein the step of extracting the invitation target customers is executed during generation of billing data for issuing bills or during generation of reminder data.

5. A method of invitation to alteration of a contract of cash loan for consumption, according to claim 4, wherein conditions for extracting each of the invitation target customers are satisfied when at least an amount billed is equal to or larger than a predetermined amount, the debtor has lived at an identical address for a predetermined number of years or longer, the debtor has a job, and the debtor is of a predetermined age or older.

6. A method of invitation to alteration of a contract of cash loan for consumption, according to claim 4, wherein conditions for extracting each of the invitation target customers during the generation of the reminder data are satisfied when default events by the debtor have occurred a predetermined number of consecutive times or smaller consecutive times, the debtor has lived at an identical address for a predetermined number of years or longer, the debtor has a job, and the debtor is of a predetermined age or older.

7. A method of invitation to alteration of a contract of cash loan for consumption, according to claim 1, wherein in the simulation of the payment plan, a remaining debt curve chart representative of changes in an outstanding loan balance with respect to monthly payment under altered payment terms is also displayed.

8. A method of invitation to alteration of a contract of cash loan for consumption, according to claim 2, wherein in the procedure for altering the present contract contents, information required for the procedure is extracted from information registered in association with the present contract, and displayed.

9. A method of invitation to alteration of a contract of cash loan for consumption, according to claim 8, including receiving alteration of the information required for the procedure.

10. A program for causing a computer to extract extracting invitation target customers each satisfying predetermined conditions from debtors, notify each of the extracted debtors of an invitation to alteration of present contract contents to other contract contents which allow relaxation of payment terms, and information concerning reception of an application for the alteration of the present contract contents, simulate a payment plan which is to be followed after the alteration to the other contract contents, based on an access from the debtor, and take a procedure for altering the present contract contents when the debtor consents to the alteration to the new contract contents based on a result of the simulation.

11. A computer-readable recording medium storing a program for causing a computer to extract extracting invitation target customers each satisfying predetermined conditions from debtors, notify each of the extracted debtors of an invitation to alteration of present contract contents to other contract contents which allow relaxation of payment terms, and information concerning reception of an application for the alteration of the present contract contents, simulate a payment plan which is to be followed after the alteration to the other contract contents, based on an access from the debtor, and take a procedure for altering the present contract contents when the debtor consents to the alteration to the new contract contents based on a result of the simulation.

12. An invitation apparatus for alteration of a contract of cash loan for consumption, the invitation apparatus inviting a debtor to alteration of contract contents concerning payment terms,
the invitation apparatus comprising:
invitation target customer-extracting means for extracting invitation target customers each satisfying predetermined conditions from debtors;
notification means for notifying each of the extracted debtors of an invitation to alteration of present contract contents to other contract contents which allow relaxation of payment terms, and information concerning reception of an application for the alteration of the present contract contents;
payment simulation means for simulating a payment plan which is to be followed after the alteration to the other contract contents, based on an access from the debtor; and
procedure-taking means for taking a procedure for altering the present contract contents when the debtor consents to the alteration to the new contract contents based on a result of the simulation,.
